(19) United States
(12) Patent Application Publication
(10) Pub. No.: US 2023/0275243 A1
(43) Pub. Date: Aug. 31, 2023

(54) FUEL CELL

(71) Applicants: JTEKT CORPORATION, Kariya-shi (JP); NATIONAL UNIVERSITY CORPORATION KANAZAWA UNIVERSITY, Kanazawa-shi (JP)

(72) Inventors: Takuya TSUJIGUCHI, Kanazawa-shi (JP); Yasuhide TAKEDA, Nisshin-shi (JP); Motoo NAKAI, Nara-shi (JP); Toshiyuki SAITO, Kashiba-shi (JP); Atsushi KUBO, Matsubara-shi (JP); Mototake FURUHASHI, Nagoya-shi (JP); Ayumi NAKASONE, Anjo-shi (JP); Atsushi NAKANE, Kariya-shi (JP); Fumitaka ACHIWA, Nagoya-shi (JP)

(73) Assignees: JTEKT CORPORATION, Kariya-shi (JP); NATIONAL UNIVERSITY CORPORATION KANAZAWA UNIVERSITY, Kanazawa-shi (JP)

(21) Appl. No.: 18/005,724

(22) PCT Filed: Aug. 25, 2021
(86) PCT No.: PCT/JP2021/031181

§ 371 Date: Jan. 17, 2023

(30) Foreign Application Priority Data
Sep. 4, 2020 (JP) 2020-148972

(51) Int. Cl. H01M 8/04291; H01M 8/0258; H01M 8/04186; H01M 8/1009

(52) U.S. Cl. CPC H01M 8/04291; H01M 8/0258; H01M 8/04186; H01M 8/1009; H01M 2008/1095

(57) ABSTRACT

A fuel cell includes a discharge structure that discharges water generated in a cathode electrode in association with an electrode reaction in the MEA to the outside. The discharge structure includes a discharge path through which air that is an oxidant flows, a passage that communicably connects an oxidant supply flow path and the discharge path and that moves water generated in the cathode electrode to the discharge path, and a discharge portion that discharges the generated water moved to the discharge path to the outside.

### TECHNICAL FIELD

The present disclosure relates to a fuel cell.

### BACKGROUND ART

A fuel cell, in particular, a polymer electrolyte fuel cell generally has an electrode structure including an anode electrode formed on one surface side of an electrolyte membrane and a cathode electrode formed on the other surface side. In the polymer electrolyte fuel cell, when fuel is supplied to the anode electrode and an oxidant is supplied to the cathode electrode from the outside, an electrode reaction occurs in the electrode structure and electric power is generated.

A direct fuel cell has been developed in recent years, in which liquid fuel such as methanol and formic acid is directly used as the fuel to be supplied to the anode electrode. The handling in the case of using the liquid fuel is easy, the energy density per volume is high, and the liquid fuel is fairly useful as compared with the case of using hydrogen gas as the fuel.

In the fuel cell, water is generated on the cathode electrode side due to the electrode reaction even when the hydrogen gas or the liquid fuel is used. In particular, when a surface of the cathode electrode is covered with the generated water in a liquid state, that is, when a flooding phenomenon occurs, the contact between a catalyst constituting the cathode electrode and oxygen (O₂) is impaired. As a result, the power generation efficiency of the fuel cell may decrease.

For this reason, for example, JP2008-108573A and JP2012-038569A disclose techniques for removing the generated water from the surface of the cathode electrode.

However, in the techniques in the related art, the generated water present in the vicinity of the surface of the cathode electrode is removed along the surface of the cathode electrode by applying the pressure of the oxidant to the generated water without actively moving the generated water in a direction away from the cathode electrode. In this case, even in a situation in which the flooding phenomenon may occur due to the presence of the generated water in a liquid state on the surface of the cathode electrode, there is a possibility that the generated water cannot be continuously and efficiently discharged to the outside of the fuel cell depending on a surface shape of the cathode electrode. In this case, as the power generation of the fuel cell continues, a large amount of the generated water in a liquid state is present on the surface of the cathode electrode. As a result, the flooding phenomenon may occur and the power generation efficiency of the fuel cell may decrease. Therefore, in the techniques in the related art, there is room for improvement in efficiently discharging the generated water in a gas state and a liquid state to the outside.

### SUMMARY OF INVENTION

An object of the present disclosure is to provide a fuel cell that can efficiently discharge water generated in association with an electrode reaction to the outside.

According to an aspect of the present disclosure, a fuel cell includes: an electrode structure including an electrolyte membrane, an anode electrode, and a cathode electrode; an anode-side separator having a fuel supply flow path through which liquid fuel is supplied to the anode electrode; a cathode-side separator having an oxidant supply flow path through which an oxidant is supplied to the cathode electrode; and a single cell in which the electrode structure is disposed between the anode-side separator and the cathode-side separator. The fuel cell generates electric power by an electrode reaction in the electrode structure. The cathode-side separator has an opposite surface provided in a position corresponding to the cathode electrode of the electrode structure, a back surface provided on a side opposite to the opposite surface in a plate thickness direction of the cathode-side separator, a passage configured to move water generated in the cathode electrode due to the electrode reaction from the opposite surface toward the back surface in the plate thickness direction, and a discharge structure configured to discharge the generated water moved to the back surface through the passage to an outside of the fuel cell.

According to this aspect, the discharge structure can discharge water generated at the cathode electrode by the electrode reaction in the electrode structure to the outside by moving the generated water from the opposite surface opposite the cathode electrode toward the back surface of the cathode-side separator through the passage provided in the cathode-side separator. That is, the discharge structure can continuously discharge water generated at the cathode electrode to the outside by moving the generated water in a direction away from the cathode electrode through the passage. Accordingly, even in a situation in which the fuel cell continues power generation, a large amount of generated water does not accumulate on the surface of the cathode electrode, and as a result, the flooding phenomenon can be prevented. Therefore, the power generation efficiency of the fuel cell can be prevented from decreasing due to water generated at the cathode electrode.

### BRIEF DESCRIPTION OF DRAWINGS

FIG. 1 shows a configuration of a fuel cell.

FIG. 2 shows a configuration of a fuel cell stack implemented by stacked single cells.

FIG. 3 shows a configuration of an anode-side separator.

FIG. 4 shows a configuration of a cathode-side separator on an opposite surface side.

FIG. 5 shows a configuration of the cathode-side separator on a back surface side.

FIG. 6 shows a configuration of a sealing member.

FIG. 7 shows a configuration of an MEA.

FIG. 8 is a cross-sectional view showing a cross section of the MEA taken along a line VIII-VIII in FIG. 7.

FIG. 9 is a cross-sectional view showing discharge of generated water.

FIG. 10 is a cross-sectional view showing a configuration of a first alternative example.

### DESCRIPTION OF EMBODIMENTS

### 1. Outline of Fuel Cell

In the present embodiment, a polymer electrolyte fuel cell is described as an example of a fuel cell. That is, in the fuel cell according to the present embodiment, an anode electrode is formed on one surface side of an electrolyte membrane, and a cathode electrode is formed on the other surface side of the electrolyte membrane. Here, the electrolyte membrane, the anode electrode, and the cathode electrode constitute a membrane electrode assembly (MEA), which is an electrode structure.

Further, the fuel cell according to the present embodiment includes an anode-side separator (including a collector) that supplies fuel to the anode electrode and a cathode-side separator (including a collector) that supplies an oxidant (oxidant gas) to the cathode electrode. The fuel cell according to the present embodiment is a fuel cell stack formed by stacking a plurality of cells (hereinafter, referred to as single cells) each including the MEA, the anode-side separator, and the cathode-side separator.

In the present embodiment, an example of the fuel supplied to the anode electrode of the fuel cell may include liquid fuel such as formic acid (HCOOH), methanol (CH₃OH), and ethanol (C₂H₅OH). Here, in the fuel cell described below, a case of directly using formic acid as the liquid fuel to be supplied will be described as an example. That is, a direct formic acid fuel cell (DFAFC), which is a polymer electrolyte fuel cell, is described as an example of the fuel cell according to the present embodiment. In the present embodiment, an example of the oxidant (oxidant gas) supplied to the cathode electrode of the fuel cell may include oxygen (O₂) gas and air. Here, in the fuel cell described below, a case of using air as the oxidant in a gas state to be supplied, that is, the oxidant gas, will be described as an example.

In the case of the direct formic acid fuel cell, when formic acid, which is liquid fuel, is directly supplied to the anode electrode of the MEA and air (O₂), which is the oxidant (oxidant gas), is supplied to the cathode electrode of the MEA, water (H₂O) is generated on a cathode electrode side due to an electrode reaction in the MEA. When the generated water aggregates and is brought into a liquid state due to cooling, the generated water covers a surface of the cathode electrode (more specifically, a catalyst layer constituting the cathode electrode) and impairs the contact between the cathode electrode and air. The fuel cell according to the present embodiment has a discharge structure in which, to discharge the generated water to the outside, water generated at the cathode electrode is moved to separate from the surface of the cathode electrode, and the moved generated water is discharged to the outside.

For this reason, in the cathode-side separator of the fuel cell according to the present embodiment, a supply path for supplying the oxidant (oxidant gas) is defined in an opposite surface opposite the cathode electrode, a discharge path is defined in a back surface of the cathode-side separator, which is on a back side of the opposite surface in a plate thickness direction, and the supply path and the discharge path are coupled by a passage defined in the plate thickness direction. Accordingly, water generated on the cathode electrode side can move through the passage from the opposite surface side of the cathode-side separator toward the discharge path defined on the back surface side, and is discharged to the outside through the discharge path. Therefore, water generated due to the electrode reaction is continuously and efficiently removed from the cathode electrode.

Since the discharge path is defined in the cathode-side separator, the oxidant (oxidant gas), that is, air, which is pressurized and supplied to the cathode electrode as an example of a pressurized fluid obtained by pressurizing the fluid, is branched so that the air may flow to the discharge path. Accordingly, the generated water that reached the discharge path through the passage is discharged to the outside, for example, together with the oxidant (air). The fluid may be suctioned from the outside to flow, for example, instead of being pressurized.

### 2. Details of Configuration of Direct Formic Acid Fuel Cell 1

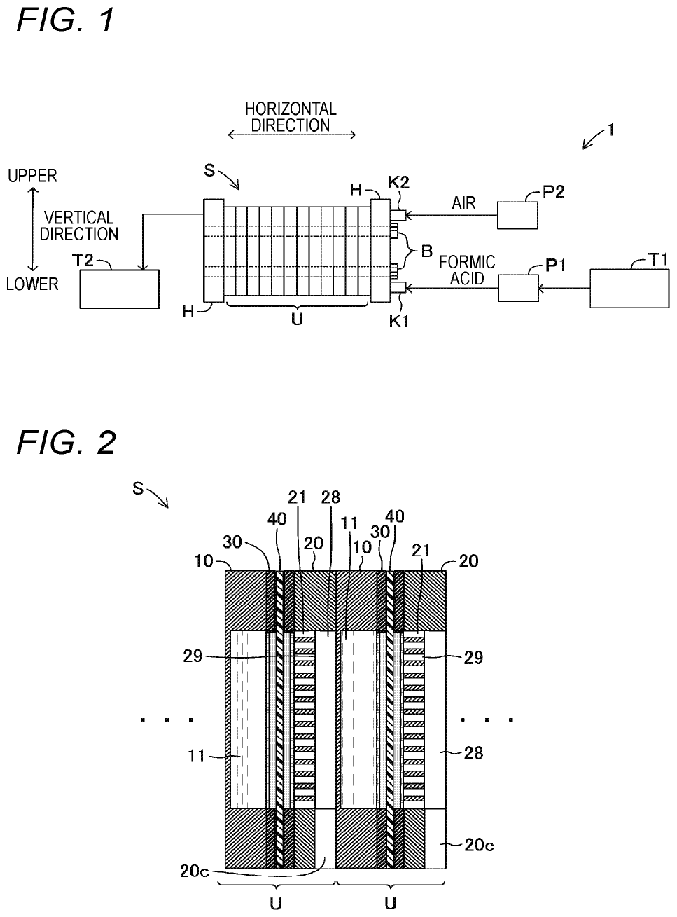

Hereinafter, configurations of the direct formic acid fuel cell 1 (hereinafter, simply referred to as “fuel cell 1”) according to the present embodiment will be described with reference to the drawings. As shown in FIG. 1, the fuel cell 1 according to the present embodiment implements a fuel cell stack S. The fuel cell stack S is in a state in which a plurality of single cells U are stacked, and the plurality of stacked single cells U are held by holders H and bolts B. The fuel cell stack S according to the present embodiment is a horizontal stack in which the plurality of single cells U arranged in a vertical direction are stacked along the horizontal direction. In the fuel cell stack S, a fuel pump P1 that pressurizes and supplies formic acid, which is liquid fuel stored in a supply tank T1, is connected to a connection portion K1 via piping (not shown). In the fuel cell stack S, a blower P2 (pressurizing pump) that pressurizes and supplies air that is an oxidant (oxidant gas) is connected to a connection portion K2 via piping (not shown).

As shown in FIG. 2, the single cell U includes an anode-side separator 10 and a cathode-side separator 20. The single cell U according to the present embodiment further includes a sealing member 30 and an MEA 40 that are stacked between the anode-side separator 10 and the cathode-side separator 20.

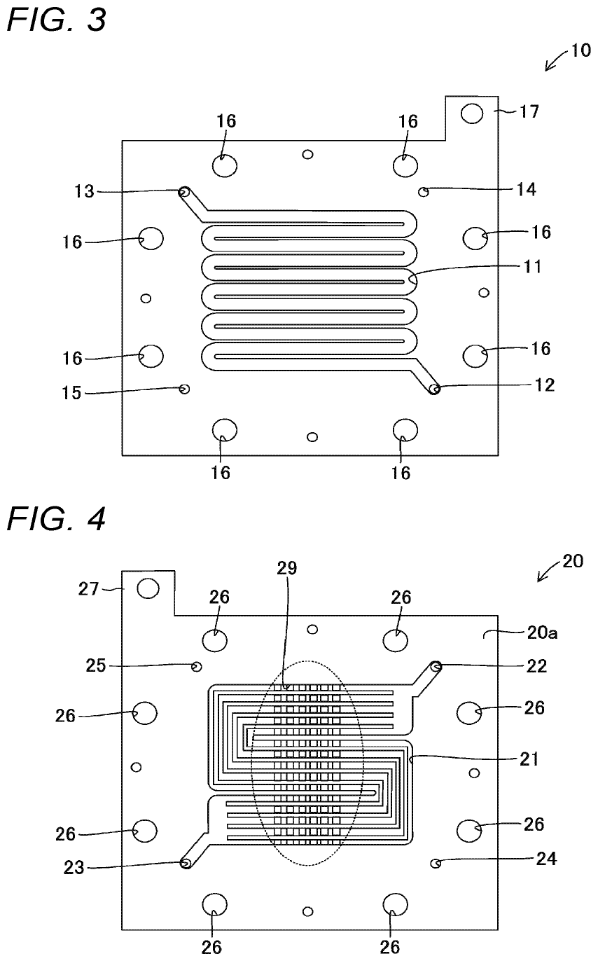

As shown in FIG. 3, the anode-side separator 10 is formed in a plate shape. The anode-side separator 10 according to the present embodiment has a current collecting function (so-called collector) of collecting electric power generated by the electrode reaction in the MEA 40, and is formed by applying a conductive treatment such as gold plating to a metal raw material, for example, a thin plate of stainless steel such as SUS316. In the present embodiment, the anode-side separator 10 is formed by a metal raw material, and may also be formed by a non-metal material having conductivity (for example, carbon, a composite material with carbon) as a raw material.

The anode-side separator 10 is formed with a fuel supply flow path 11 in a central portion thereof, that is, in a position opposite the MEA 40 (more specifically, anode electrode layer AE that is an anode electrode to be described later). The fuel supply flow path 11 supplies formic acid, which is liquid fuel, to the anode electrode layer AE. As shown in FIG. 3, the fuel supply flow path 11 according to the present embodiment is formed in a meandering manner. The anode-side separator 10 is further provided with, in a peripheral edge portion thereof, a fuel supply port 12 for supplying formic acid to the fuel supply flow path 11 and a fuel discharge port 13 for discharging formic acid that passed through the fuel supply flow path 11.

The fuel supply port 12 is supplied with formic acid pressurized by the fuel pump P1 (see FIG. 1) provided outside the fuel cell stack S. The fuel pump P1 pressurizes and supplies formic acid stored in the supply tank T1 (see FIG. 1). The fuel discharge port 13 is connected to a recovery tank T2 (see FIG. 1) provided outside the fuel cell stack S, and discharges the discharged formic acid to the recovery tank T2. The anode-side separator according to the present embodiment is provided with the fuel supply port 12 on a lower side in the vertical direction and the fuel discharge port 13 on an upper side in the vertical direction in a state in which the fuel cell stack S is installed. The fuel supply port 12 may be provided on the upper side in the vertical direction, and the fuel discharge port 13 may be provided on the lower side in the vertical direction if necessary.

Accordingly, in the single cell U according to the present embodiment, formic acid pressurized by the fuel pump P1 is supplied to the fuel supply flow path 11 from the supply tank T1 through the fuel supply port 12, and formic acid flowing through the fuel supply flow path 11 reaches the fuel discharge port 13 while being in contact with the anode electrode layer AE. That is, in the present embodiment, formic acid supplied from the fuel supply port 12 flows the fuel supply flow path 11 from the lower side to the upper side in the vertical direction, and reaches the fuel discharge port 13. Formic acid that reached the fuel discharge port 13, that is, unreacted formic acid is recovered in the recovery tank T2.

The anode-side separator 10 is further provided with, in the peripheral edge portion thereof, a through hole 14 and a through hole 15 for supplying air to the cathode-side separator 20 constituting the single cell U and discharging unreacted air. The through holes 14, 15 are provided in respective positions shifted from the fuel supply port 12 and the fuel discharge port 13 by, for example, 90 degrees. The anode-side separator 10 is further provided with, in the peripheral edge portion thereof, a plurality of (eight in FIG. 3) large-diameter insertion holes 16 for inserting the bolts B of the holders H, and an electrode portion 17 that extracts electric power to the outside. The electrode portion 17 may also be provided only on the anode-side separator 10 constituting the single cell U which is located at, for example, an end portion when the fuel cell stack S is implemented.

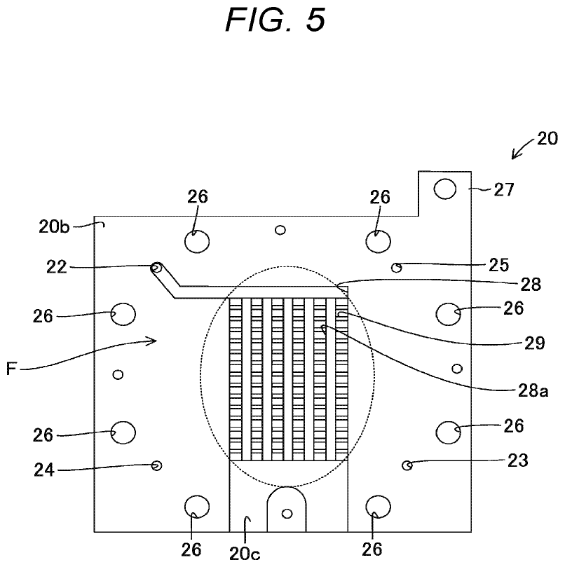

As shown in FIGS. 4 and 5, the cathode-side separator 20 is formed in a plate shape. The cathode-side separator 20 according to the present embodiment has a current collecting function (so-called collector) of collecting electric power generated by the electrode reaction in the MEA 40, and is formed by applying a conductive treatment such as gold plating to a metal raw material, for example, a thin plate of stainless steel such as SUS316. In the present embodiment, the cathode-side separator 20 is also formed by a metal raw material similarly to the anode-side separator 10, and may also be formed by a non-metal material having conductivity (for example, carbon, a composite material with carbon) as a raw material.

As shown in FIG. 4, the cathode-side separator 20 is formed with an oxidant supply flow path 21 in a central portion thereof in an opposite surface 20a opposite the MEA 40 (more specifically, cathode electrode layer CE that is a cathode electrode to be described later). The oxidant supply flow path 21 supplies air, which is an oxidant (oxidant gas), to the cathode electrode layer CE. As shown in FIG. 4, the oxidant supply flow path 21 according to the present embodiment is formed as a meandering-shaped recess and protrusion (groove).

The cathode-side separator 20 is further provided with, in a peripheral edge portion thereof, an oxidant supply port 22 for supplying air, that is, oxygen (O₂) to the oxidant supply flow path 21 and an oxidant discharge port 23 for discharging air that passed through the oxidant supply flow path 21. Air pressurized by the blower P2 (see FIG. 1) provided outside the fuel cell stack S is supplied to the oxidant supply port 22. In the present embodiment, the fuel cell 1 includes the blower P2 and air is pressurized and supplied by the blower P2. However, the blower P2 may be omitted as necessary.

The oxidant discharge port 23 discharges the discharged air to the outside of the fuel cell stack S. Accordingly, in the single cell U according to the present embodiment, air, that is, oxygen (O₂) pressurized by the blower P2 is supplied from the oxidant supply port 22 to the oxidant supply flow path 21, and air, that is, oxygen (O₂) flowing through the oxidant supply flow path 21 reaches the oxidant discharge port 23 while being in contact with the cathode electrode layer CE. Unreacted air (oxygen (O₂)) that reached the oxidant discharge port 23 is discharged to the outside of the fuel cell stack S.

The cathode-side separator 20 is further provided with, in the peripheral edge portion thereof, a through hole 24 and a through hole 25 for supplying formic acid to the anode-side separator 10 constituting the single cell U and discharging unreacted formic acid. The through holes 24, 25 are provided in respective positions shifted from the oxidant supply port 22 and the oxidant discharge port 23 by, for example, 90 degrees.

The cathode-side separator 20 is further provided with, in the peripheral edge portion thereof, a plurality of (eight in FIGS. 4, 5) large-diameter insertion holes 26 for inserting the bolts B of the holders H, and an electrode portion 27 that extracts electric power to the outside. The electrode portion 27 may be provided only on the cathode-side separator 20 constituting the single cell U which is located at, for example, an end portion when the fuel cell stack S is implemented.

Here, the fuel supply port 12 of the anode-side separator 10 is communicate with the through hole 24 of the cathode-side separator 20, and the fuel discharge port 13 of the anode-side separator 10 is communicate with the through hole 25 of the cathode-side separator 20. The oxidant supply port 22 of the cathode-side separator 20 is communicate with the through hole 14 of the anode-side separator 10, and the oxidant discharge port 23 of the cathode-side separator 20 is communicate with the through hole 15 of the anode-side separator 10. That is, the through holes 14, 15 of the anode-side separator 10 are formed corresponding to the oxidant supply port 22 and the oxidant discharge port 23 of the cathode-side separator 20, and the through holes 24, 25 of the cathode-side separator 20 are formed corresponding to the fuel supply port 12 and the fuel discharge port 13 of the anode-side separator 10.

As shown in FIG. 5, the cathode-side separator 20 is further formed with a discharge structure F at a central portion of a back surface 20b on a back side of the opposite surface 20a in the plate thickness direction of the cathode-side separator 20. The discharge structure F discharges water (H₂O) generated by the electrode reaction in the MEA 40 (cathode electrode layer CE) to the outside of the fuel cell stack S (single cell U). As shown in FIG. 5, the discharge structure F includes a discharge portion 20c, a discharge path 28, and passages 29.

The discharge path 28 according to the present embodiment is implemented by a plurality of linear recesses and protrusions, specifically, six linear grooves 28a in FIG. 5. The discharge path 28 according to the present embodiment is formed, for example, by being rotated by 90 degrees relative to the linear portion of the oxidant supply flow path 21 formed in the opposite surface 20a. One end side, that is, an upstream side, of the groove 28a of the discharge path 28 is connected to the oxidant supply port 22, and the other end side, that is, a downstream side, of the groove 28a of the discharge path 28 is connected to the discharge portion 20c formed in the cathode-side separator 20 to communicate with the outside in a state in which the fuel cell stack S is implemented.

In the present embodiment, the discharge structure F further includes the discharge portion 20c and the discharge path 28, and the discharge path 28 is connected to the discharge portion 20c. However, instead of the discharge portion 20c (discharge portion 20c is omitted), the discharge path 28 (groove 28a) may extend to an end portion of the cathode-side separator 20 and discharge the generated water (H₂O) to the outside of the fuel cell stack S (single cell U).

Here, in the cathode-side separator 20 according to the present embodiment in a state in which the fuel cell stack S is installed, the oxidant supply port 22 is disposed on the upper side in the vertical direction, and the discharge portion 20c is disposed on the lower side in the vertical direction. That is, in the discharge path 28 according to the present embodiment, the upstream side connected to the oxidant supply port 22 is the upper side in the vertical direction, and the downstream side connected to the discharge portion 20c is the lower side in the vertical direction.

Accordingly, in a state in which the single cells U are stacked to form the fuel cell stack S, a part of air pressurized by the blower P2 and supplied to the oxidant supply port 22 flows through the oxidant supply flow path 21 as an oxidant (oxidant gas), and the other part of the air flows through the discharge path 28 (groove 28a) as a pressurized fluid. That is, air supplied to the oxidant supply port 22 is branched and flows through the oxidant supply flow path 21 and the discharge path 28 (groove 28a).

The passages 29 connect the oxidant supply flow path 21 (more specifically, groove defining the oxidant supply flow path 21) in the opposite surface 20a of the cathode-side separator 20 and the discharge path 28 (more specifically, groove 28a) in the back surface 20b of the cathode-side separator 20 so that the oxidant supply flow path 21 and the discharge path 28 are communicable in the plate thickness direction of the cathode-side separator 20. As shown by being surrounded by broken lines in FIGS. 4 and 5, a plurality of (for example, 90) passages 29 are provided in the present embodiment, in which openings in the opposite surface 20a and the back surface 20b are slit-shaped, and cross sections orthogonal to an axial direction (that is, direction in which the passages 29 extend) are quadrangular-shaped through holes.

Here, in the present embodiment, for example, the groove of the oxidant supply flow path 21 is defined in the opposite surface 20a at a depth that is a half of the plate thickness of the cathode-side separator 20, and the groove 28a of the discharge path 28 is defined in the back surface 20b at a depth that is the half of the plate thickness of the cathode-side separator 20 along the direction rotated by 90 degrees relative to the oxidant supply flow path 21. That is, in the present embodiment, as shown in FIGS. 4 and 5, the direction of the groove of the oxidant supply flow path 21 in positions of the passages 29 intersects with the direction of the groove 28a of the discharge path 28 in the positions of the passages 29. Accordingly, in the present embodiment, when the oxidant supply flow path 21 and the discharge path 28 are defined, the passages 29 having a quadrangular shape in cross section are defined.

Accordingly, as will be described later, water (H₂O) generated in the cathode electrode layer CE by the electrode reaction in the MEA 40 moves from the opposite surface 20a of the cathode-side separator 20 toward the back surface 20b, that is, from the oxidant supply flow path 21 toward the discharge path 28, through the passages 29. Then, the generated water (H₂O) that reached the discharge path 28 through the passages 29 is discharged to the outside from the discharge portion 20c of the cathode-side separator 20 together with air flowing through the discharge path 28. That is, the discharge structure F including the discharge portion 20c, the discharge path 28, and the passages 29 can move water (H₂O) generated in the cathode electrode layer CE by the electrode reaction in the MEA 40 in a direction away from the cathode electrode layer CE and discharge the generated water to the outside.

Here, when air flows through the linear discharge path 28 (groove 28a), the pressure in the discharge path 28 relatively decreases due to a difference in flow velocity of air (or difference in pressure loss) compared to the pressure in the meandering-shaped oxidant supply flow path 21, and the generated water (H₂O) in a gas state (water vapor) easily moves toward the discharge path 28 through the passages 29. When the generated water (H₂O) is condensed and liquefied, a capillary phenomenon due to the surface tension of the generated water (H₂O) in a liquid state occurs, and the generated water (H₂O) easily moves toward the discharge path 28 through the passages 29. Therefore, the discharge structure F can efficiently discharge the generated water (H₂O) to the outside of the fuel cell stack S (single cell U).

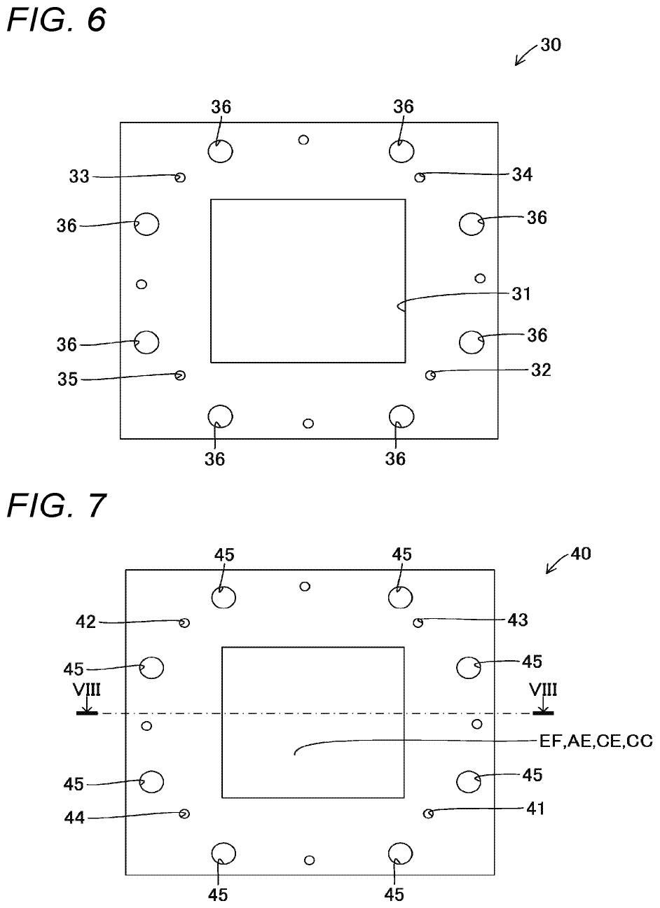

As shown in FIG. 6, the sealing member 30 is formed in a plate shape. Here, the sealing member 30 is formed by an elastic material, for example, a rubber material such as an EPDM and an elastomer material. The sealing member 30 is used in pair, sandwiches the MEA 40, and is sandwiched by the anode-side separator 10 and the cathode-side separator 20.

The sealing member 30 includes, in a central portion thereof, an accommodation portion 31 penetrating the sealing member 30 to accommodate the anode electrode layer AE and the cathode electrode layer CE of the MEA 40. Accordingly, in a state in which the sealing member 30 sandwiches the MEA 40, formic acid supplied through the fuel supply flow path 11 of the anode-side separator 10 flows inside the accommodation portion 31 and is supplied to the anode electrode layer AE. Further, in the state in which the sealing member 30 sandwiches the MEA 40, air supplied through the oxidant supply flow path 21 of the cathode-side separator 20 flows through the inside of the accommodation portion 31 and is supplied to the cathode electrode layer CE.

The sealing member 30 is further formed with, in a peripheral edge portion thereof in a state in which the single cell U is implemented, through holes 32, 33 in positions corresponding to the fuel supply port 12 (corresponding to the through hole 24 of the cathode-side separator 20) and the fuel discharge port 13 (corresponding to the through hole 25 of the cathode-side separator 20) provided in the anode-side separator 10. Accordingly, in the state in which the single cell U is implemented, the fuel supply port 12 (through hole 24) communicates with the through hole 32, and the fuel discharge port 13 (through hole 25) communicates with the through hole 33.

The sealing member 30 is further formed with, in the peripheral edge portion thereof in the state in which the single cell U is implemented, through holes 34, 35 in positions corresponding to the oxidant supply port 22 (corresponding to the through hole 14 of the anode-side separator 10) and the oxidant discharge port 23 (corresponding to the through hole 15 of the anode-side separator 20) provided in the cathode-side separator 20. Accordingly, in the state in which the single cell U is implemented, the oxidant supply port 22 (through hole 14) communicates with the through hole 34, and the oxidant discharge port 23 (through hole 15) communicates with the through hole 35. The sealing member 30 is further formed with, in the peripheral edge portion, insertion holes 36 for inserting the bolts B of the holders H.

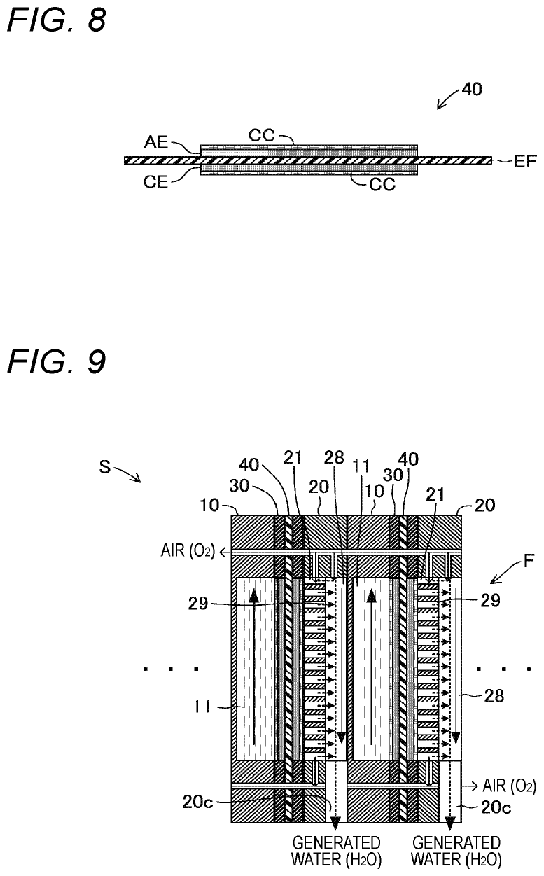

As shown in FIGS. 7 and 8, the MEA 40 that is an electrode structure mainly includes an electrolyte membrane EF, the anode electrode layer AE that is an anode electrode to which formic acid is supplied, and the cathode electrode layer CE that is a cathode electrode to which air is supplied. The anode electrode layer AE and the cathode electrode layer CE are formed by stacking a predetermined catalyst on the electrolyte membrane EF in a layer shape. Since the electrode reaction of the electrolyte membrane EF, the anode electrode layer AE, and the cathode electrode layer CE is widely known, detailed description thereof will be omitted in the following description.

The electrolyte membrane EF according to the present embodiment is formed by an ion exchange membrane (for example, Nafion (registered trademark) manufactured by DuPont) that selectively transmits cations (more specifically, hydrogen ions (H⁺)). As shown in FIG. 7, the electrolyte membrane EF is formed with, in a peripheral edge portion thereof in the state in which the single cell U is implemented, through holes 41, 42 in positions corresponding to the fuel supply port 12 (corresponding to the through hole 24 of the cathode-side separator 20) and the fuel discharge port 13 (corresponding to the through hole 25 of the cathode-side separator 20) provided in the anode-side separator 10, and the through holes 32, 33 of the sealing member 30. Accordingly, in the state in which the single cell U is implemented, the fuel supply port 12 (through holes 24, 32) communicates with the through hole 41, and the fuel discharge port 13 (through holes 25, 33) communicates with the through hole 42.

The electrolyte membrane EF is further formed with, in the peripheral edge portion thereof in the state in which the single cell U is implemented, through holes 43, 44 in positions corresponding to the oxidant supply port 22 (corresponding to the through hole 14 of the anode-side separator 10) and the oxidant discharge port 23 (corresponding to the through hole 15 of the anode-side separator 20) provided in the cathode-side separator 20, and the through holes 34, 35 of the sealing member 30. Accordingly, in the state in which the single cell U is implemented, the oxidant supply port 22 (through holes 14, 34) communicates with the through hole 43, and the oxidant discharge port 23 (through holes 15, 35) communicates with the through hole 45. The electrolyte membrane EF is further formed with, in the peripheral edge portion, insertion holes 45 for inserting the bolts B of the holders H.

The anode electrode layer AE and the cathode electrode layer CE that are electrode layers mainly contain carbon (supported carbon) supporting a noble metal catalyst (for example, palladium (Pd), platinum (Pt)), and are formed in a layer shape on a surface of a center portion of the electrolyte membrane EF as shown in FIG. 8. Here, the anode electrode layer AE and the cathode electrode layer CE formed in a layer shape have a slightly larger thickness than the thickness of the sealing member 30. The anode electrode layer AE and the cathode electrode layer CE formed in a layer shape further have a slightly smaller outer dimension than the size of the accommodation portion 31 of the sealing member 30.

As shown in FIG. 8, surface sides of the anode electrode layer AE and the cathode electrode layer CE are covered with a carbon cloth (or carbon paper) CC that is a diffusion layer formed of conductive fibers. The carbon cloth CC diffuses formic acid supplied to the anode electrode layer AE and air supplied to the cathode electrode layer CE, and efficiently supplies electric power generated by the electrode reaction to the anode-side separator 10 and the cathode-side separator 20.

That is, since the carbon cloth CC is fibrous, the supplied formic acid and air are uniformly diffused by conduction between fibers. Further, since the carbon cloth CC has conductivity, the generated electric power can efficiently flow to the anode-side separator 10 and the cathode-side separator 20.

As shown in FIG. 2, the single cell U is formed by sequentially stacking the anode-side separator 10, the sealing member 30, the MEA 40, the sealing member 30, and the cathode-side separator 20 in the horizontal direction. Here, when the single cell U is implemented, the respective members may adhere to each other in an airtight manner using, for example, a conductive adhesive as necessary.

A plurality of the implemented single cells U are stacked according to a required output, thereby constituting the fuel cell stack S. In the fuel cell stack S having the above configuration, the fuel supply ports 12 and the fuel discharge ports 13 of the anode-side separators 10 are in communication with each other among the stacked single cells U via the through holes 24, 25 of the cathode-side separators 20, and the like. In the fuel cell stack S, the oxidant supply ports 22 and the oxidant discharge ports 23 of the cathode-side separators 20 are in communication with each other among the stacked single cells U via the through holes 14, 15 of the anode-side separator 10, and the like.

In the following description, a communication passage implemented by the fuel supply port 12 of the anode-side separator 10, the through hole 24 of the cathode-side separator 20, and the like and through which formic acid flows is referred to as a “fuel-side manifold”. A communication passage implemented by the oxidant supply port 22 of the cathode-side separator 20, the through hole 14 of the anode-side separator 10, and the like and through which air flows is referred to as an “oxidant-side manifold”.

### 3. Operation of Fuel Cell 1

Next, the operation of the fuel cell 1 implemented by the fuel cell stack S having the above configuration will be described. In the fuel cell 1, formic acid pressurized by the fuel pump P1 is supplied to the anode electrode layer AE of each single cell U through the fuel-side manifold. In the fuel cell 1, air from the blower P2 is supplied to the cathode electrode layer CE of each single cell U through the oxidant-side manifold.

That is, in each single cell U as shown in FIG. 9, formic acid supplied through the fuel supply port 12 of the anode-side separator 10 flows through the fuel supply flow path 11 toward the fuel discharge port 13. Accordingly, formic acid, which is liquid fuel, is supplied to the anode electrode layer AE of the MEA 40. In each single cell U, air supplied through the oxidant supply port 22 of the cathode-side separator 20 is branched, so that a part of the air flows through the oxidant supply flow path 21 toward the oxidant discharge port 23 and the other part of the air flows through the discharge path 28 toward the discharge portion 20c. Accordingly, the air which is an oxidant (oxidant gas) flowing through the oxidant supply flow path 21 is supplied to the cathode electrode layer CE of the MEA 40.

In the MEA 40 of each single cell U, as is well known, water (H₂O) is generated in the cathode electrode layer CE by the electrode reaction using formic acid (HCOOH) and air (oxygen (O₂)). Specifically, in the present embodiment, the electrolyte membrane EF of the MEA 40 is formed by an ion exchange membrane that selectively transmits cations. For this reason, in the MEA 40, water (H₂O) is generated in the cathode electrode layer CE according to the following chemical reaction formulas 1 and 2.

Anode electrode layer AE: HCOOH→2H⁺+2e⁻+CO₂ Chemical reaction formula 1

Cathode electrode layer CE: 2H⁺+2e⁻+(½)O₂→H₂O Chemical reaction formula 2

Here, in the fuel cell 1 according to the present embodiment, the single cells U are stacked in the horizontal direction to form the fuel cell stack S. Further, in the fuel cell 1 according to the present embodiment, the discharge structure F is provided along the vertical direction. Accordingly, as shown by broken lines in FIG. 9, water (H₂O) in a gas state (water vapor) or a liquid state generated by the electrode reaction in the cathode electrode layer CE passes through the passages 29 of the discharge structure F and moves from the opposite surface 20a (that is, cathode electrode layer CE side) of the cathode-side separator 20 to the back surface 20b (that is, discharge path 28 side).

In the discharge path 28 (groove 28a), air branched at the oxidant supply port 22 flows toward the discharge portion 20c. Therefore, the generated water (H₂O) that moved through the passages 29 is discharged from the discharge portion 20c to the outside of the fuel cell stack S together with the air flowing through the discharge path 28. Further, the discharge structure F is formed along the vertical direction, that is, the discharge portion 20c is disposed on the lower side in the vertical direction. For this reason, when water (H₂O) generated in a gas state (water vapor) by the heat accompanying the electrode reaction of the MEA 40 is cooled and liquefied when passing through the passages 29, the generated water (H₂O) moves toward the discharge portion 20c by the pressure of the air flowing through the discharge path 28 and the weight of the generated water (H₂O) in a liquid state, and is discharged to the outside of the fuel cell stack S.

As described above, since the fuel cell 1 (more specifically, fuel cell stack S) has the discharge structure F, excessive water (H₂O) generated by the electrode reaction is continuously and efficiently discharged from the cathode electrode layer CE. This makes it less likely for the generated water (H₂O) to accumulate in the vicinity of the cathode electrode layer CE. As a result, a flooding phenomenon in which the surface of the cathode electrode layer CE is covered with the condensed (liquefied) generated water (H₂O) can be prevented. Therefore, a contact area in which air (O₂) supplied through the oxidant supply flow path 21 is in contact with the cathode electrode layer CE is prevented from being reduced. Accordingly, for example, even when the power generation of the fuel cell 1 continues, the electrode reaction efficiency in the cathode electrode layer CE does not decrease, and as a result, the power generation efficiency of the fuel cell 1 can be prevented from decreasing.

As can be understood from the above description, according to the fuel cell 1 according to the present embodiment, water (H₂O) generated in the cathode electrode layer CE (cathode electrode) by the electrode reaction in the MEA 40 that is an electrode structure moves away from the vicinity of the cathode electrode layer CE by the discharge structure F including the discharge portion 20c, the discharge path 28, and the passages 29, and is discharged to the outside of the fuel cell 1 together with air. Accordingly, even in a situation where the fuel cell 1 continues power generation, excessive (large amount) water (H₂O) generated by the electrode reaction can be continuously discharged to the outside, and power generation efficiency of the fuel cell 1 can be prevented from decreasing due to a flooding phenomenon caused by the excessive (large amount) generated water (H₂O).

### 4. First Alternative Example

In the present embodiment described above, water generated in the cathode electrode layer CE is discharged to the outside of the fuel cell stack S (single cell U) together with air flowing through the discharge path 28 of the discharge structure F. In the fuel cell 1, when power generation continues, for example, the noble metal catalyst or the carbon cloth CC that is a diffusion layer of the anode electrode layer AE may be contaminated, and power generation efficiency may decrease. For this reason, in the fuel cell 1, a refresh operation of cleaning the anode electrode layer AE side is performed at regular intervals. The refresh operation is, for example, an operation of circulating cleaning water on the anode electrode layer AE side in place of formic acid that is liquid fuel. By circulating the cleaning water, the anode electrode layer AE side can be cleaned, and the power generation efficiency can be improved again.

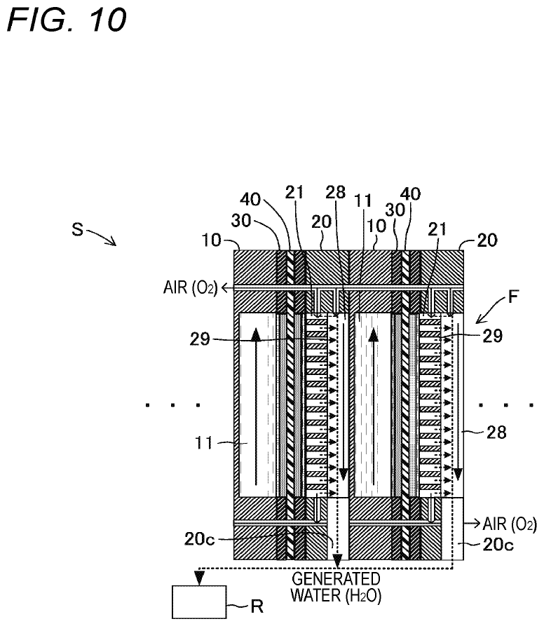

Therefore, in the first alternative example, water generated in the cathode electrode layer CE can be used as cleaning water. Specifically, in the first alternative example, as shown in FIG. 10, the generated water (in a gas state or a liquid state) discharged from the discharge structure F is collected and stored in the reservoir tank R via, for example, a tube (not shown). The generated water discharged in a gas state is cooled before being collected in the reservoir tank R, and is collected and stored in the reservoir tank R as the generated water in a liquid state.

The generated water stored in the reservoir tank R is added to, for example, cleaning water separately prepared for the refresh operation, circulates on the anode electrode layer AE side, and cleans the anode electrode layer AE. Accordingly, the generated water can be effectively used for the refresh operation, and the reduced power generation efficiency of the fuel cell 1 can be returned to the normal power generation efficiency by the refresh operation.

### 5. Other Alternative Examples

In the present embodiment and the first alternative example described above, the discharge path 28 having the plurality of linear grooves 28a is defined in the back surface 20b of the cathode-side separator 20. Instead of providing the plurality of grooves 28a, a wide recess in the central portion of the back surface 20b, which has one end side (upstream side) connected to the oxidant supply port 22 and the other end side (downstream side) connected to the discharge portion 20c, may also be used as the discharge path 28. In this case, the passages 29 are formed by drilling or the like, and connect the oxidant supply flow path 21 and the discharge path 28 formed as described above so that the oxidant supply flow path 21 and the discharge path 28 are communicable in the plate thickness direction of the cathode-side separator 20. In this case as well, the same effects as those according to the present embodiment and the first alternative example described above can be obtained.

Further, in the present embodiment and the first alternative example described above, the cross-sections orthogonal to axes of the passages 29 are quadrangular. However, the shapes of the passages 29 in cross section are not limited to quadrangular, and may be, for example, circular or polygonal other than quadrangular. Even when the shapes of the passages 29 in cross section are other than quadrangular, the same effects as those according to the present embodiment and the first alternative example described above can be obtained by communicably connecting the oxidant supply flow path 21 and the discharge path 28 by the passages 29.

In addition, in the present embodiment and the first alternative example described above, the positions of the discharge path 28 and the passages 29 are set to the central portion of the cathode-side separator 20 in accordance with the position of the oxidant supply flow path 21. However, the positions of the discharge path 28 and the passages 29 and the size of the discharge path 28 are not limited to the position and the size of the oxidant supply flow path 21 in the central portion of the cathode-side separator 20. For example, the discharge path 28 and the passages 29 may be provided in the peripheral edge portion of the cathode-side separator 20 as long as the oxidant supply port 22, the oxidant discharge port 23, and the through holes 24, 25 are not affected.

In the present embodiment and the first alternative example described above, the fuel cell stack S is formed by stacking in the horizontal direction a plurality of single cells U arranged in the vertical direction. However, the present disclosure is not limited thereto as long as water (H₂O) generated in the cathode electrode layer CE can be discharged to the outside by passing through the passages 29, the discharge path 28, and the discharge portion 20c. That is, in this case, instead of disposing the fuel cell stack S horizontally as in the present embodiment described above, a fuel cell stack may also be formed by stacking in the vertical direction a plurality of single cells U arranged in the horizontal direction, that is, the fuel cell stack S may be disposed vertically.

Further, in the present embodiment and the first alternative example described above, air that is an oxidant to be supplied to the cathode electrode layer CE is branched at the oxidant supply port 22, and the branched air, that is, the pressurized fluid flows through the discharge path 28. However, without branching the air, air which is a separately supplied fluid may flow as a pressurized fluid to the discharge path 28. In this case as well, the same effects as those according to the present embodiment and the first alternative example described above can be obtained. When the fluid is separately supplied, for example, air that is the fluid may be suctioned from the discharge portion 20c side, and the suctioned air may flow to the discharge path 28.

The present application is based on Japanese Patent Application No. 2020-148972 filed on Sep. 4, 2020, and the contents thereof are incorporated herein as reference.

1. A fuel cell comprising:
an electrode structure including an electrolyte membrane, an anode electrode, and a cathode electrode;
an anode-side separator having a fuel supply flow path for supplying liquid fuel to the anode electrode;
a cathode-side separator having an oxidant supply flow path for supplying an oxidant to the cathode electrode; and
a single cell in which the electrode structure is disposed between the anode-side separator and the cathode-side separator, wherein
the fuel cell generates electric power by an electrode reaction in the electrode structure, and
the cathode-side separator has:
an opposite surface provided in a position corresponding to the cathode electrode of the electrode structure;
a back surface provided on a side opposite to the opposite surface in a plate thickness direction of the cathode-side separator;
a passage configured to move water generated in the cathode electrode due to the electrode reaction from the opposite surface toward the back surface in the plate thickness direction; and
a discharge structure configured to discharge the generated water moved to the back surface through the passage to an outside of the fuel cell.

2. The fuel cell according to claim 1, wherein
the discharge structure has a discharge path provided in the back surface and communicating with the passage, and
the passage communicably connects the oxidant supply flow path and the discharge path.

3. The fuel cell according to claim 2, wherein
when a fluid flows in a state in which the electrode reaction occurs in the electrode structure, the discharging path discharges the generated water moved to the back surface through the passage to the outside of the fuel cell.

4. The fuel cell according to claim 3, wherein
the oxidant supplied to the oxidant supply flow path is branched in the discharge structure, and
the discharge path flows the branched oxidant as the fluid.

5. The fuel cell according to claim 3, wherein
the oxidant supply flow path is formed in a meandering shape, and the discharge path is formed in a linear shape, and
when the fluid flows, pressure inside the discharge path is lower than pressure inside the fuel supply flow path.

6. The fuel cell according to claim 2, wherein
in a position where the passage is formed, a direction in which the oxidant supply flow path extends and a direction in which the discharge path extends intersect with each other.

7. The fuel cell according to claim 2, wherein
the discharge path is disposed along a vertical direction.

8. The fuel cell according to claim 1, wherein
the opposite surface and the back surface have an opening, and
the opening is provided in a slit shape in the passage.

9. The fuel cell according to claim 1, wherein
a cross-sectional shape of the passage orthogonal to a direction in which the passage extends is one of circular shape and polygonal shape.

10. The fuel cell according to claim 1, further comprising:
a reservoir tank configured to collect and store the generated water discharged by the discharge structure.

11. The fuel cell according to claim 10, wherein
the generated water stored in the reservoir tank is used as cleaning water for cleaning the anode electrode.

12. The fuel cell according to claim 1, wherein
the liquid fuel supplied to the anode electrode is formic acid.
